(19) United States
(12) Patent Application Publication
(10) Pub. No.: US 2006/0132523 A1
(43) Pub. Date: Jun. 22, 2006

(54) 2 Dimensional laser-based optical printer encoder

(76) Inventors: Tong Xie, San Jose, CA (US); Marshall Thomas DePue, San Jose, CA (US)

Correspondence Address: AVAGO TECHNOLOGIES, LTD., P.O. BOX 1920, DENVER, CO, 80201-1920, US

(21) Appl. No.: 11/019,605

(22) Filed: Dec. 21, 2004

(51) Int. Cl. B41J 29/38

(52) U.S. Cl. 347/16

(57) ABSTRACT

The present invention is a printer that includes an optical encoder that accurately represents the actual motion of the paper in both X and Y directions. The optical encoder uses a coherent or quasi-coherent illumination source. A detector may be used to capture images produced from the reflected light off the print media.

### BACKGROUND

Inkjet printers advance the paper after each print swath of the inkjet pen. Ideally, the paper is advanced exactly the amount needed to match the nozzle pattern from one print swath to the next. This way the resulting printed image appears to be made by one continuous pen and has high image quality. However, if the paper is advanced too far or too little, even the small discontinuity of the nozzle groupings is easily apparent to the human eye. Paper advances that are too long result in a high contrast white gap in the otherwise continuous print. Paper advances that are too short can appear as a dark band if the nozzle print overlaps. In either case, consistently long or short paper advance errors add up to distort the printed image, e.g. a printed circle could appear to be slightly elliptical. Additionally, the paper may move laterally resulting in text that is no longer co-linear or text with incorrect kerning.

Inkjet printers that use shaft encoders coupled to the drive motor or rollers are prone to swath advance errors as described above. A shaft encoder can give accurate feedback of the rotation of the shaft/roller but that does not necessarily correspond to exact motion of the paper. If a drive roller has a larger than nominal diameter, it will advance the paper more than desired. If it has a smaller than nominal diameter, it will give a smaller than desired advance for the same amount of angular rotation. In addition, if intermediate drive rollers or gears rotate about a center with an eccentric error, they can give the paper advance varying large and small swath errors. Another limitation for the shaft encoders is that they only track motion in one dimension. Side-to-side motion of the print media cannot be detected using the shaft encoder.

U.S. Pat. No. 5,149,980 described an optical encoder developed at Hewlett Packard in the early 1990's using a light emitting diode (LED) source to illuminate the print media at an oblique angle. The oblique illumination of the LED light produces highlights and shadows on surfaces with large roughness features. An image sensor is used to capture the shadow images on the print media and a correlation-based algorithm can be used to determine relative motions between the paper and the encoder. It has been shown that this type of optical encoders may provide highly accurate paper motion feedback; swath advances have been measured to be accurate to one micron per swath advance. Capability of 2D motion encoding of the print media has also been demonstrated using this method.

However, the usability of the oblique LED-based optical encoder is limited by media types with large surface roughness, e.g. white bond paper. Print media with very smooth surface can produce shadow images with contrast too low for the image correlation algorithm to work. In has been found that the oblique LED-based optical encoder does not function on glossy photo paper and transparency films.

### SUMMARY

The present invention is a motion encoder which accurately measures the actual motion of the paper in both X and Y directions for a Cartesiam coordinate system. An optical encoder uses a coherent or quasi-coherent illumination source. An array sensor may be used to capture images of the surface, speckle patterns, or diffraction images produced from the reflected light off the print media.

In one embodiment, diffraction images are detected. The contrast of the diffraction pattern is related to the degree of coherence of the light source and it is independent of the surface type.

### BRIEF DESCRIPTION OF THE DRAWINGS

FIG. 1 ilustrates an embodiment of the present invention.

FIGS. 2A-C illustrate a paper transport assembly of the present invention.

FIG. 3 ilustrates an embodiment of the present invention.

FIG. 4 ilustrates an embodiment of the present invention.

FIG. 5 ilustrates an embodiment of the present invention.

FIG. 6 illustrates a laser printer of the present invention.

### DETAILED DESCRIPTION

The present invention is a printer that includes a two dimensional (2D) optical encoder for tracking motion of the print media. A coherent or quasi-coherent light source, e.g. laser such as a laser diode or a vertical cavity surface emitting laser (VCSEL), a light emitting diode (LED) or a combination of a broadband source and an optical filter, illuminates a surface of the print media. The surface detection technique begins when a preselected angular distribution of reflected light is captured by a detector. The detector, e.g. an array sensor, is preferably positioned to capture the image from the surface. The image may directly correspond to the surface, or be a derivative of surface information, e.g. speckle patterns or diffraction images produced from the reflected light off the print media.

In one embodiment, the images are obtained from the specular direction of the reflected light as shown in FIG. 1. Specular reflection typically provides a better signal compared to the shadow pattern image approach. This configuration allows high contrast images to be obtained even on extremely smooth surfaces. Additionally, image quality is preserved with respect to Lambertian surfaces because light is still scattered into the specular direction. The specular reflection images depend upon the illumination source, e.g. the contrast of the specular reflection images increases as the bandwidth of the illumination source decreases, therefore laser-based illumination provides the highest contrast. This technique is described by Xie, et al. in more detail in “Method and Device for Optical Navigation”, U.S. application Ser. No. 10/680,525, filed Oct. 6, 2003, assigned to Agilent Technologies.

FIGS. 2A-C illustrate a paper transport assembly 10 using an encoder 11 of the present invention. In FIG. 2A, a VCSEL source 12 is used. An optional imaging optics 14 together with an image sensor 16, e.g. 2D detector array, is positioned along the specular direction of the reflected light. This configuration efficiently collects the reflected light. The imaging optics 16 are designed to form either an image of the print surface, an image of a speckle pattern, or a diffraction image onto the 2D detector 16. This image may be further refined by including an optional imaging lens 18 prior to the image sensor 16. An image processor (not shown) uses known techniques, e.g. image correlation, to determine the paper's position and its motion characteristics, e.g. velocity. The results may be either absolute position or position relative to a known fiducial in the paper transport assembly. The detected positional information is feedback to the image processor for close loop control and compensation of paper/print header error.

FIG. 2B illustrates a laser-based motion encoder 11 that may be integrated as part of the printhead (not shown). FIG. 2C illustrates a laser-based motion encoder 11 left as a standalone encoder unit attached to a fixed position on a printer chassis (not shown).

As shown in FIGS. 2A-C, the laser-based encoder 11 includes a coherent light source 12, e.g. a laser such as a vertical cavity surface emitting laser (VCSEL), and a detector 16, e.g. a CMOS image array. The coherent light source 12 illuminates the print media with a light beam at an angle of illumination with respect to the surface. The detector 16 is positioned at an angle of reflection with respect to the surface operable to receive a reflected portion of the light beam from the surface, wherein the angle of reflection is substantially equal to the angle of illumination.

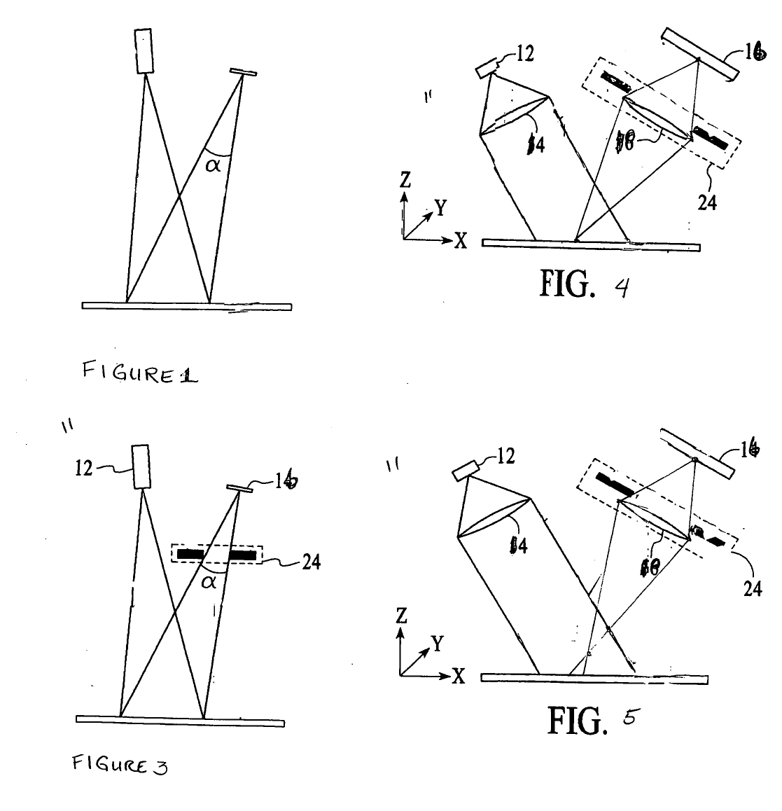

When the detected pattern is speckle, FIG. 3 illustrates the operation of an encoder of the present invention. A laser is positioned proximate to a surface. The reflected light is incident upon a detector. The angle of incidence need not equal the angle of reflection. An aperture 24 may be positioned in the light collection path to obtain a speckle pattern whose statistical spatial distribution has a preselected average size.

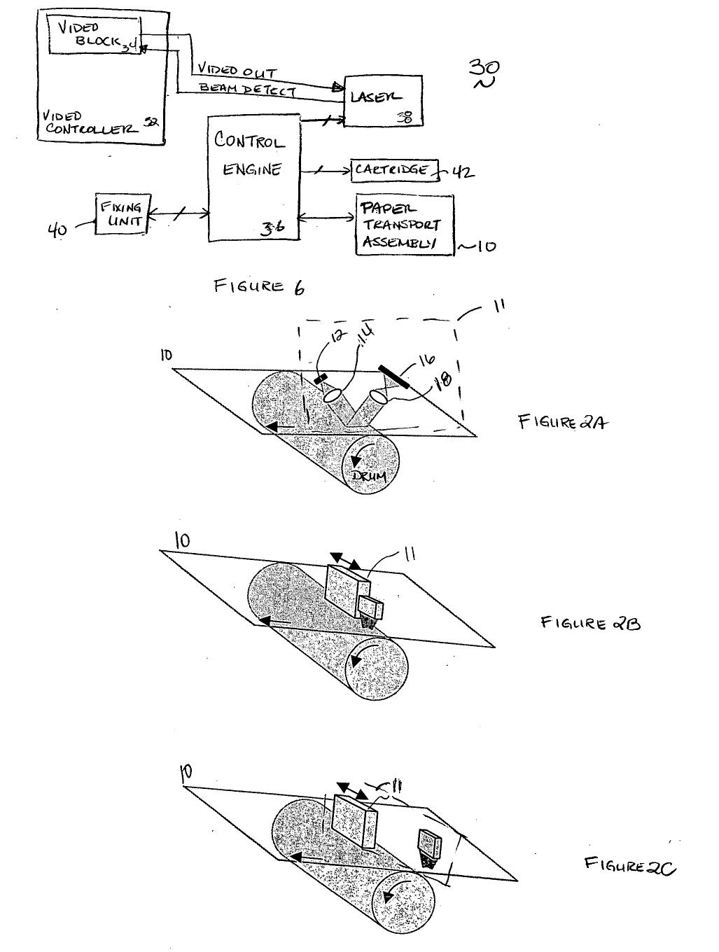

When the detected pattern is diffraction, FIG. 4 illustrates an encoder 11 using both the optional collimating and imaging lenses. An optional aperture 24 is positioned in the light collection path. In this embodiment, the aperture 24 improves the image contrast. In this imaging configuration, the imaging lens 18 is positioned such that the image of the print surface is formed onto the detector.

FIG. 5 illustrates an alternate encoder 11 using both the optional collimating and imaging lenses 14, 18. This encoder 11 similar to that in FIG. 4 detects diffraction patterns. An optional aperture 24 is positioned in the light collection path. The imaging optics 18 are designed to image a plane in space that does not coincide with the print media onto the image sensor 16. In other words, the imaging path of the encoder is defocused from the print surface. The defocused configuration helps to filter any unidirectional or repetitive patterns on the print surface.

FIGS. 4 and 5 allow for detection of different surfaces. A printer using one of these encoders is insensitive to paper thickness and paper motion perpendicular to the feed direction because there is relatively constant spatial resolution over a large depth of field. In addition, the printer manufacturing tolerances may be relaxed. A printer applying laser navigation technology allows direct 2D motion tracking of the print media. The new method is insensitive to the surface types and offers constant spatial resolution over a large depth-of-field (DOF).

FIG. 6 illustrates a laser printer 30 of the present invention. A video controller 32, that includes a video block 34, connects to a control engine 36 and a laser 38. A fixing unit 40 bidirectionally connects to the control engine 36. The control engine 36 connects to a toner cartridge 42 and a media transport assembly 10, e.g. paper transport assembly.

Alternatively, the laser-based motion encoder 116 may be used in an ink-jet printer. The ink-jet printer includes a printhead for printing on a medium. The printhead is disposed at a print area for ejecting droplets of ink onto a surface of the medium in a controlled fashion during printing operations. An input supply of print media disposed at an input end of a primary media path. The path guiding the medium from the input supply and past the print area. A laser-based encoder is positioned proximate to the primary media path, generating a signal indicative of the print media position. The inkjet printer further includes first means for advancing a sheet of medium from the input supply into the input end of the primary media path and second means for advancing the medium from a location on the primary path upstream from the print area through the primary feed path to position the medium in relation to the printhead.

All of the aforementioned embodiments generate sequences of images that are analyzed by the control engine to determine the position of the media. Snapshots of the media position may be compared with a desired path. The desired path is known to give the optimal print quality. It is determined by parameters including paper movement and printing mechanism motion. Under closed loop feedback control, the control engine may adjust either the transport assembly or printing mechanism to conform to the desired path. In addition, the control engine can determine the paper velocity to detect a paper jam condition.

1. A printer comprising:
a media transport assembly receiving print media, including a 2D optical encoder positioned proximate to the print media, generating a signal indicative of the print media position; and
a print control engine, receiving the signal and generating a response;
the media transport assembly receiving the response.

2. A printer, as defined in claim 1, the 2D optical encoder including:
a light source for illuminating the print media with a light beam at an angle of incidence with respect to the surface, the light source is one of a coherent and quasi-coherent source; and
a detector positioned at an angle of reflection with respect to the surface operable to receive a pattern corresponding to a reflected portion of the light beam from the surface.

3. A printer, as defined in claim 2, wherein the light source is a coherent light source, the coherent light source selected from a group consisting of laser diodes and vertical cavity surface emitting lasers.

4. A printer, as defined in claim 3, wherein the light source is a quasi-coherent light source, the quasi-coherent light source selected from a group consisting of light emitting diodes and broadband source with an optical filter.

5. A printer, as defined in claim 2, wherein the detector is a CMOS imager.

6. A printer, as defined in claim 2, wherein the angle of incidence is substantially equal to the angle of reflection.

7. A printer, as defined in claim 2, further including a lens positioned to be operable to image a diffraction image of the surface onto the detector.

8. A printer, as defined in claim 7, wherein the surface does not lie in the nominal image plane of the detector.

9. A printer, as defined in claim 2, the pattern being selected from a group including speckle, diffraction, and surface image.

10. A method comprising:
moving media in a printer;
applying a light source towards a surface of the media, the source is one of a coherent and quasi-coherent source;
detecting a pattern corresponding to a reflection of the surface; and
analyzing the pattern to determine actual position of the media.

11. The method, as defined in claim 10, wherein the pattern is selected from a group including speckle, diffraction, and surface image.

12. The method, as defined in claim 10, wherein:
analyzing comprises comparing the actual position of the surface with a preferred path; and
positioning the media according to a difference between the actual position of the surface and the preferred path.

13. The method, as defined in claim 10, wherein:
analyzing comprises comparing the actual position of the surface with a preferred path; and
adjusting a printing mechanism according to the comparison.

14. The method, as defined in claim 10, wherein the light source is a coherent light source, the coherent light source is selected from a group consisting of laser diodes and vertical cavity surface emitting lasers.

15. The method, as defined in claim 10, wherein the light source is a quasi-coherent light source, the quasi-coherent light source selected from a group consisting of light emitting diodes and broadband source with an optical filter.

16. The method, as defined in claim 10, wherein the detector is a CMOS image array.

17. The method, as defined in claim 10, comprising positioning a lens to image a diffraction image of the surface onto the detector.

18. The method, as defined in claim 10, wherein the surface does not lie in the nominal image plane of the detector.
